(19) United States
(12) Patent Application Publication
(10) Pub. No.: US 2002/0078191 A1
(43) Pub. Date: Jun. 20, 2002

(54) User tracking in a Web session spanning multiple Web resources without need to modify user-side hardware or software or to store cookies at user-side hardware

(76) Inventor: Todd Lorenz, Belmont, CA (US)

Correspondence Address: Ivan S. Kavrukov, Cooper & Dunham LLP, 1185 Avenue of the Americas, New York, NY, 10036, US

(21) Appl. No.: 09/742,849

(22) Filed: Dec. 20, 2000

(51) Int. Cl. G06F 17/00; G06F 15/173

(52) U.S. Cl. 709/223; 709/238

(57) ABSTRACT

A tracking system tracks user interaction with Web resources over the Internet and maintains continuity as the user changes hosts during the Web session, without relying on cookies. An entry point activated by the user, such as a loaded link in an email, routs a request for a Web resource to a gateway facility different from the host of the Web resource. The gateway facility processes the request, modifies is as needed, keeps tracking information, and sends the modified request to the server that actually hosts the Web resource the user sought. The response to the modified request goes to the gateway facility, which modifies it as needed, keeps tracking information, and then sends it to the user, with loaded links that point back to the gateway facility to thereby

### FIELD

This patent specification is in the field of tracking user interactions with resources over networks, such as interactions of a user at a PC with Web resources over the Internet.

### BACKGROUND

Many businesses that deal with others via the Internet find it useful to seek information that might help their business, and a number of systems exist for this purpose. A company with an Internet address <www.doubleclick.com> is a prominent example of a business that works with a number of clients to provide tracking information. Typically, when a user operating a personal computer (PC) visits a Web page of a DoubleClick client such as a marketing company, a “cookie” is placed on the hard drive of the visitor's PC and points to a unique record of that computer in DoubleClick's database. A code in the cookie allows DoubleClick to identify subsequent visits by the same user and to link these with data gathered for other clients affiliated with DoubleClick. If in a later visit the user provides further identifying information, such as a name, email and/or geographical address, etc., this can be linked with previously collected information about the user as well as with information collected in user transactions with Web resources in the future. The information can be used in a great number of ways, such as to improve marketing and advertizing. Other companies such as Engage and MatchLogic are believed to provide services similar to DoubleClick.

A user can set a Web browser such as Internet Explorer or Netscape Navigator to provide a warning before a new cookie is stored at the user-side computer, or can set the browser to deny access to cookies. In addition, there are commercially available products such as GuardDog from McAfee Software, Norton Internet Security from Symantec, and interMute from <www.intermute.com> that can block banner ads and shut ad-network cookies from the user-side computer. Some commercially available products can be used to decide which cookies to block and which to allow to be stored at the user-side computer. Blocking cookies associated with a particular server from being stored by a client defeats cookie-based tracking of that user by that server.

Products are available from sources such as <www.anonymizer.com> and <www.zeroknowledge.com> that allow a user not only to block cookie placement by a server from which the user requests a Web resource but also to further hide the user's identity by masking items such as the address if the user's IP provider.

In typical tracking of a user's actions using cookies, the tracking can end when the user changes to a different Web server in the same Web session. For example, if the user visits the Web site of company A, where actions such as clicks on a Web page from company A are tracked, and then during the same Web session types in the URL of company B that is not a client of the tracking facility, the tracking facility may not be able to track the user's clicks on the Web page from company B and, so, may not maintain tracking continuity throughout the Web session.

At least one tracking facility, <www.yesmail.com>, is said to track by having the user's request for a Web resource redirected to YesMail, which responds by creating tracking information and issuing a re-direct to the server that actually provides the requested Web resource to the user. This is believed to require substantially permanent and manual modification of information that the user would see, such as Web pages, to make hyperlinks therein point to YesMail rather than to the actual Web resource. Given this supposition, all hyperlinks to be tracked would have to be so modified; the moment a user clicks on a hyperlink that has not been so modified, tracking would halt. Further, it is believed that continuous tracking of a unique user may be difficult with this system without the use of cookies, as each permanently placed hyperlink would be constructed to accommodate all users rather than only a particular user, and therefore would not contain information unique to a given user.

To illustrate by way of examples, consider first a simple Web session that involves neither active tracking nor cookies. Assume a user at a user-side computer facility such as a personal computer configured with a Web browser receives an email marketing message from Yahoo.com, and the message includes the link with a single, plain URL <http://www.yahoo.com/index.html>. When the user clicks on this link in the email reader, a Web browser at the user side opens and soon the user sees Yahoo's home page displayed on the monitor. In this case, the user's Web browser can be called the true Web client; that is, the application from which the request for the Web resource—Yahoo's home page-originates. The user's Web browser in this case makes its request via http, a language adopted for Web clients and Web servers, by which requests for and responses with Web resources are formulated. The Web browser knows to use http by looking at the “method” portion of the url in the link, namely <http> in this example, although there also are other, perhaps less common, methods in general use. The host portion of the url tells the Web browser where to send its http request—<www.yahoo.com>.

At a computer facility identified on the Internet as “www.yahoo.com” there is a Web server, an application that listens for http requests and processes them. In this case, the request is for the Web resource as indicated in the “path” portion of the url—“/index.html.” So, the Web server knows to look for a Web resource named “index.html” in the root of its Web documents directory. Upon locating it, it responds back to Web client, via http. Note that in this example the host “www.yahoo.com” houses the true Web server, that is, the application that has access to the requested Web resource in its original form and is responsible for providing that Web resource in its response to the Web client. The Web server typically logs certain items of information related to this transaction. For instance: the time of the transaction; the name and path of the requested Web resource; and IP of the Web client machine; the “make and model” of the Web client (e.g., whether MS Internet Explorer 4.0, or Netscape Navigator 3.0, etc.), the status of the transaction (whether successful or not); etc. However, in these examples of items loggable by the Web server there is nothing definitively to identify the user as a unique individual in the transaction just described. So, if the user initiates another transaction with “www.yahoo.com,” for example by clicking another link, another server log entry will be generated, but there will be no definitive correlation with a record generated by the prior transaction between the user and Yahoo.com.

The Web server logs described above can be useful for collecting certain types of aggregate statistics on a given host, but may not be of much use for tracking individual users. Reporting applications such as WebTrends can process such Web server logs to provide aggregate information such as: “this Web resource was requested this many times,” or “the most requests for this Web resource came during this part of the day,” or “there were this many transaction errors this week,” etc. The fact that one http transaction may not be able to be correlated to another derives from the fact that http can be characterized as a stateless protocol in which one http transaction doesn't know about another.

To provide some correlation, cookies can be used as a client-side state retention mechanism. To extend the example discussed above to the use of cookies, assume the user points the Web browser at the host “www.yahoo.com,” and that Yahoo! wants to “tag” users of its Web site so that, in spite of the statelessness of http transactions, a particular user may be identified as so-and-so on subsequent visits. Thus, when responding to the user's request for some Web resource, the Web server on “www.yahoo.com” might preamble the response with a directive to the user's Web browser to “set a cookie” with, for example, the literal text “USER 123”. Assume the user's Web browser is configured to accept cookies. Then, the browser will write a small text file (typically no larger than 4K, and not executable) to the user's local hard drive, containing, literally, the text “USER 123”. That is the cookie in this example. When the user next visits “www.yahoo.com” (on the very next click or at a later time), the user's Web browser will preamble its request with the data stored in the cookie. Yahoo!'s Web server can grab that cookie before responding to the user's request, and use it to identify the user as “USER 123”. The information in the cookie may be more specific than “USER 123.” For example, if Yahoo!'s cookie directive had been made along with the response to a form submission wherein the user John Doe gave his email address, then the cookie might contain the actual email address, such as <jdoe@MSN.com>. So long as that cookie is set in the user's computer (and cookies are “activated” in the user's Web browser), the Web server on “www.yahoo.com” can identify the user positively as the one having the email address <jdoe@msn.com> any time John Doe (or someone at John Doe's computer) requested another Web resource from Yahoo, thus providing for tracking. Similar use can be made of actual names or other personal information a user may provide by filling in forms on the screen or in some other ways.

A limitation of cookies is that they are exchanged between the user's Web browser and the hosts that placed them. For example, Yahoo typically cannot see a cookie that was placed by Excite, or vice-versa. Thus, the typical use of cookies does not involve tracking between hosts, e.g., if the user is being tracked through the use of a cookie while transacting with Yahoo, tracking might not continue when the user changes to Excite. Of course, no tracking of any kind through cookies would take place if the user has configured his or her Web browser not to accept cookies. Moreover, some Web browsers will agree to store only a limited number of cookies at the same time, e.g., 20 cookies, which can further limit tracking through cookies.

In the above example, the Web server grabs the cookie from the user's Web browser, but often it is the Web resource and not the server that makes the best use of the cookie for tracking purposes. If the Web resource is a Web application—generally a CGI or some program that creates html dynamically—then the cookie (made available to the CGI by the Web server) may be logged by the application, or used in the generation of its html output. Tracking with cookies in this manner requires more extensive server infrastructure, such as one or more Web applications waiting to handle various cookie-laden requests, or a specially configured Web server to handle the work of such applications, or some other solution.

As earlier mentioned, a company called YesMail, at <www.yesmail.com>, is believed to offer a system in which requests for Web resources are routed through YesMail by the use of specially modified hyperlinks. This is believed to allow some tracking of user actions, but offers no general continuity of tracking as the user navigates to a different Web resource via unmodified hyperlinks. Further, it offers no convenient control over the content of the Web resources served back in the response to the user, as the response comes as a result of a redirect to the true Web server. A systems of this kind is not admitted to be prior art because it may have become available as possible prior art after the development of the system disclosed in this patent specification and less than a year before the filing date of this patent specification.

### SUMMARY OF THE DISCLOSURE

An object of the system disclosed in this patent specification is to track interactions of a user with Web resources. Another object is to continue tracking as the user navigates from one Web resource or host to another in a Web session. Yet another object is to do so without a need to make changes at user-side hardware or software, or to use cookies. Another object is to conveniently and efficiently modify at will the content of Web resources served back to the user as a result of a request. Still another object is to do so in a particularly efficient and cost-effective manner, and to produce particularly useful, varied, and easily customized tracking information.

In an embodiment that is representative and not limiting of the scope of this patent specification, a user's request for a Web resource is routed to a gateway facility rather than directly to the server that provides the requested Web resource. One way to do this is to include in information supplied to the user, e.g. in email to the user or a Web page sent to the user, an offer of a Web resource that contains an entry point such as a loaded link that appears on the user's screen. If the user is interested in the resource and activates the entry point, for example by clicking a link, the request goes to the gateway facility rather than directly to the facility that will ultimately provide the Web resource. From then on, the gateway facility can remain functionally between the user and any Web resource (host or server) with which the user interacts (transacts) in the Web session. The gateway facility can be a server operating under appropriate software, and in the representative example disclosed here can be called the APT (Adaptive Proxy Tracking) server, or simply APT.

The first time the entry point information from a given user for a given Web session reaches the gateway facility, the APT decodes the information and extracts therefrom session parameters indicative of who is the user (if this is available), what is the Web resource the user is seeking, etc. If any session parameters are missing or incorrect, the gateway facility uses its built-in intelligence to fill in gaps. Provided the gateway facility finds both an entry point and context in a request received from a user, it expands the request if and as needed, such as by using one or more look-up tables, and again uses its built-in intelligence to fill in any gaps in the result of the expansion. The gateway server uses the resulting information to consult an agenda that provides directions on what to do in response to that information, and than executes these directions. The directions can be as specific or as general as needed for a particular business purpose. For example, the direction may pertain to the collection of tracking information about the user and the request, to the creation and maintenance of databases, to redirection of the request, to ending the Web session, etc. The gateway server then typically issues a request to the Web server that actually contains, or can otherwise provide, the Web resource sought by the user.

Thus, it is the gateway facility that first receives the Web response the user sought when activating the entry point. In response to receiving this Web resource, the gateway facility again consults the agenda, this time on the basis of information contained in the response. For example, the agenda may direct that links to Web resources in the response be changed to include entry points that lead to the gateway facility rather than directly to respective Web resources. The direction may also direct that some other information in the response be changed, e.g., to include the user's name if known, or to otherwise change information in the response. Typically, the directions also include rules on what information should be logged for tracking purposes and how.

The gateway facility sends the so-modified response to the user and, if the user activates one of the entry points in the modified response or otherwise activates an entry point, the process starting with the receipt of entry point information at the gateway facility is repeated, this time on the basis of information related to the new entry point. This can continue for the entire Web session, thus maintaining tracking and logging continuity despite the user moving from one Web resource to another and one client server to another. The gateway facility or a service associated therewith can arrange and analyze the collected tracking information in a variety of way.

### BRIEF DESCRIPTION OF THE DRAWING

FIG. 1 is a flow chart illustrating steps of a process representative of a preferred embodiment.

FIG. 2 is an example of an email containing entry points to a process of the type FIG. 1 illustrates.

FIG. 3 illustrates a simple agenda.

FIG. 4 illustrates a look-up table consulted for an entry transaction when the context is known.

FIG. 5 illustrates another, more complex agenda.

FIG. 6-9 illustrate various ways of presenting tracking information.

FIG. 10 is a schematic illustration of information flow in accordance with one embodiment.

### DETAILED DESCRIPTION OF PREFERRED EMBODIMENTS

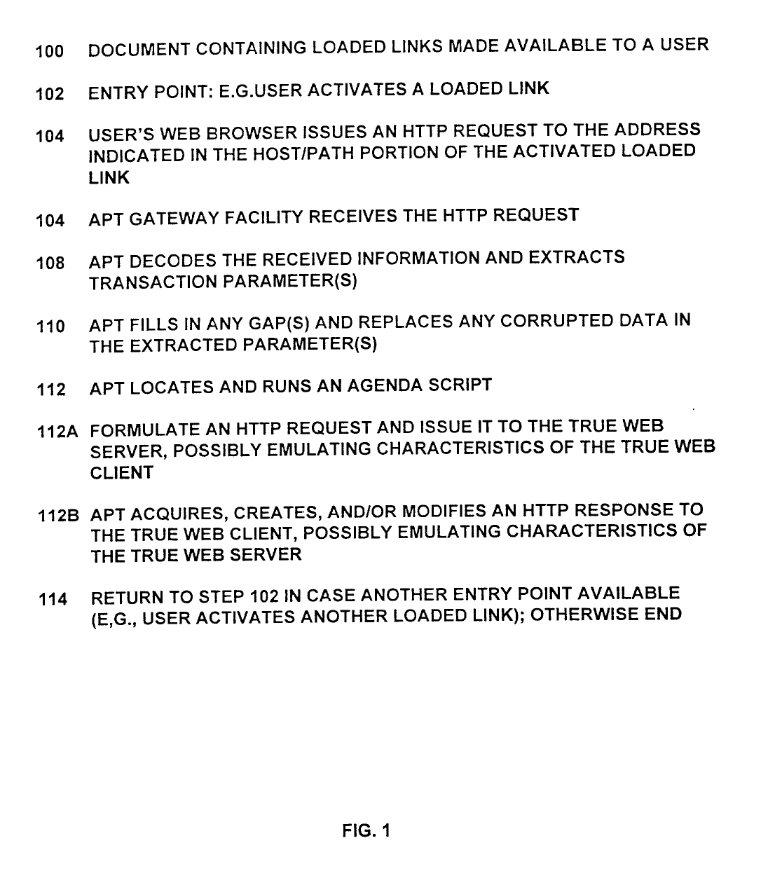

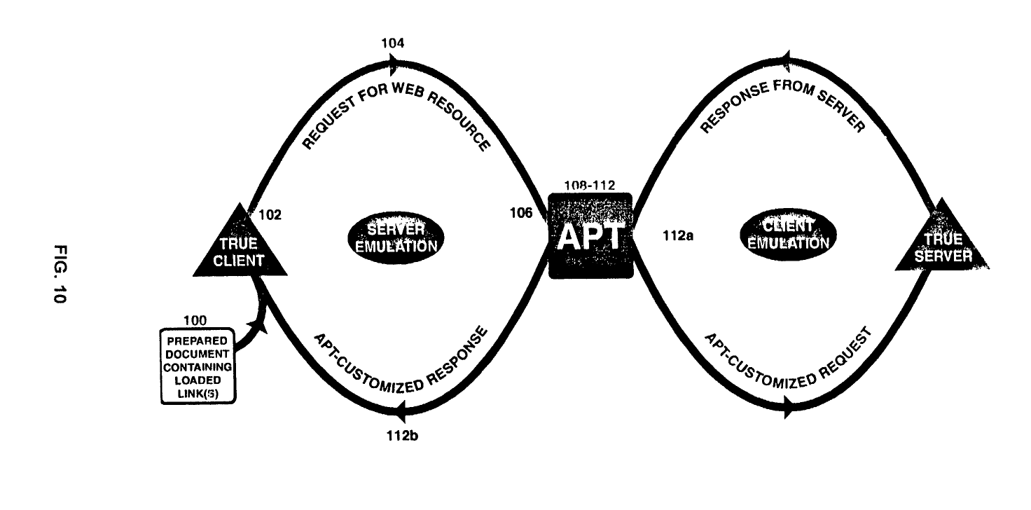

Referring to FIGS. 1 and 10, in one illustrative embodiments the process starts at step 100 when a document prepared to contain one or more LOADED LINKs is made available to a user at user-side hardware configured with appropriate software that includes a Web browser. Assume for the sake of an example that the prepared document is an email message delivered to the user as a part of a campaign on behalf of a business entity called Fictico.com. Many other types of prepared documents can be used as well, including without limitation Web pages, intranet documents, and even print material.

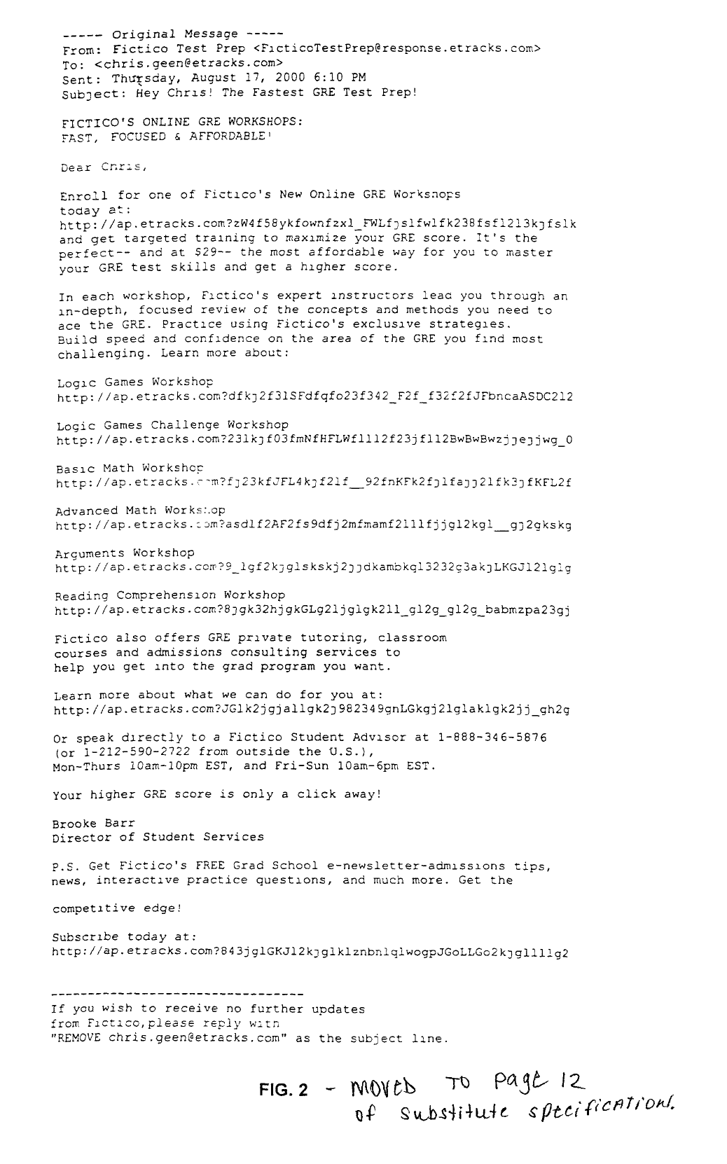

An example of such an email is illustrated in FIG. 2. As seen in the header, it is sent to a user having the email address “chris.geen@etracks.com”. The body of the message seeks to interest the user in online workshops, and contains several LOADED LINKs that the user can click or otherwise activate to request, through his or her Web browser, a Web resource offering more information. Note that each of the LOADED LINKs has a query string portion (delimited by a question mark on the left) containing encoded TRANSACTION PARAMETERs.

A LOADED LINK may be defined as any URL addressed to an APT gateway facility (comprising an APT application running on a server connected to the Internet using conventional means) and bearing one or more TRANSACTION PARAMETERs, whether encoded or in the clear, whether borne in the query string or elsewhere. Some examples of TRANSACTION PARAMETERs in a LOADED LINK are, but are not limited to:

(1) USER ID, which can be any value that uniquely identifies a particular user, such as that user's email address;

(2) CONTEXT, which can identify the exact point at which a user entered a session, can be of the format CLIENT ID/CAMPAIGN ID:CELL ID:LINK ID, and can be carried through the entire session;

(3) AGENDA ID, which can identify a particular AGENDA SCRIPT containing instructions that can govern the behavior of a particular transaction;

(4) SOURCE, which can contain the address of the Web resource on which was activated a

(5) REQ URL, which can be the address of a specific Web resource requested by the user;

(6) etc.

As will be demonstrated, LOADED LINKs are a means of keeping a user engaged in a client-server relationship with APT no matter where the user navigates. Furthermore, TRANSACTION PARAMETERs in LOADED LINKs are a means of maintaining state between consecutive APT transactions (without the use of cookies) where, normally, HTTP transactions are stateless. (“HTTP” is a protocol by which requests for and responses with Web resources are formulated by Web clients and Web servers. It is a “stateless” protocol in that each HTTP transaction is completely independent of every other; no data is maintained by the protocol between transactions.)

At step 102 in the process, the user activates a LOADED LINK. Say that, for our example, our user activates the top link in the email message, under the words, “Enroll for one of Fictico's New Online GRE Workshops.” This is termed the ENTRY POINT; it is the very first LOADED LINK activated by the user. Its activation initiates an APT transaction, possibly leading to additional related APT transactions, which collectively will constitute an APT session.

At step 104, the user's Web browser issues an HTTP request to the address indicated in the host/path portion of the LOADED LINK, “ap.etracks.com.”

The APT gateway facility so indicated receives the request at step 106. Here, the APT is interacting with the user's Web browser, termed the TRUE WEB CLIENT, in the role of Web server.

At step 108, APT extracts any or all TRANSACTION PARAMETERs from the information supplied thereto over the Internet as a result of the user activating a LOADED LINK.

Assume that the query string of the LOADED LINK in our example (now available to APT as part of the HTTP request) contains two TRANSACTION PARAMETERs, placed and encoded at the time of the preparation of the email message. APT decodes and parses these TRANSACTION PARAMETERs, which are revealed to be USER ID and CONTEXT with the literal values, respectively, “chris.geen@etracks.com” and “:260/5:0:0.” (In addition to any TRANSACTION PARAMETERs obtained at this step, APT will of course have access to all of the information normally available to a Web server when a request is made of it by a Web client. In a typical HTTP exchange, this information can include data submitted in forms; data present in cookies; information about the user's Web browser; the IP address of the machine from which the request originated; etc.

At step 110 of the process, APT fills in any gaps in the extracted TRANSACTION PARAMETERs. Depending on the particular use to which the process is put, certain TRANSACTION PARAMETERs can be considered essential and APT can generate or obtain values for those that are missing or have been corrupted. To this end, APT can use its own built-in intelligence that may comprise rules on what to do in the case of specified missing or corrupted parameters, in specified combination, at specified times, etc.

For instance, if the USER ID is unavailable amongst the initial TRANSACTION PARAMETERS for whatever reason, APT can generate an arbitrary unique ID for the user; or, if another more meaningful unique identifier is available from some other source (such as from a cookie, or from form data), APT may fill in such other information for the USER ID.

Missing or corrupted data such as TRANSACTION PARAMETERs for which appropriate values cannot be generated or extrapolated from information available locally to the APT process can often be obtained from some external repository of data, generally termed a “database,” that may comprise, but is not limited to, a flat file, hash table, LDAP database, relational database, etc. This type of action generally termed a LOOKUP. Any item of information available to APT may be used as the “key” to a LOOKUP.

To continue our example, APT performs a LOOKUP to obtain values for the AGENDA ID and REQ URL. The AGENDA ID tells APT where to find a script defining one or more actions to perform for the current transaction; and the REQ URL tells APT where to find the actual Web resource requested by the user at the TRUE WEB CLIENT—a Web resource having to do with “Fictico's New Online GRE Workshops” and likely residing on a different server (i.e. the TRUE WEB SERVER). These two TRANSACTION PARAMETERs could, of course, have been encoded into the LOADED LINK that served as the ENTRY POINT for this session. However, for various reasons it is often desirable to keep the length of clickable URLs in email messages below a certain minimum, and therefore, we'll say for this example that the AGENDA ID and REQ URL were excluded from the query string the sake of keeping it short.

In this example, APT makes the decision to perform a LOOKUP on the basis of the presence of a colon as the first character in the CONTEXT value extracted from the query string. This is an arbitrary indicator signifying to APT that it is processing an entry transaction originating at an ENTRY POINT in an email message, and that expansion via LOOKUP of the TRANSACTION PARAMETERs is necessary. APT uses the remainder of the CONTEXT itself as the key to the LOOKUP.

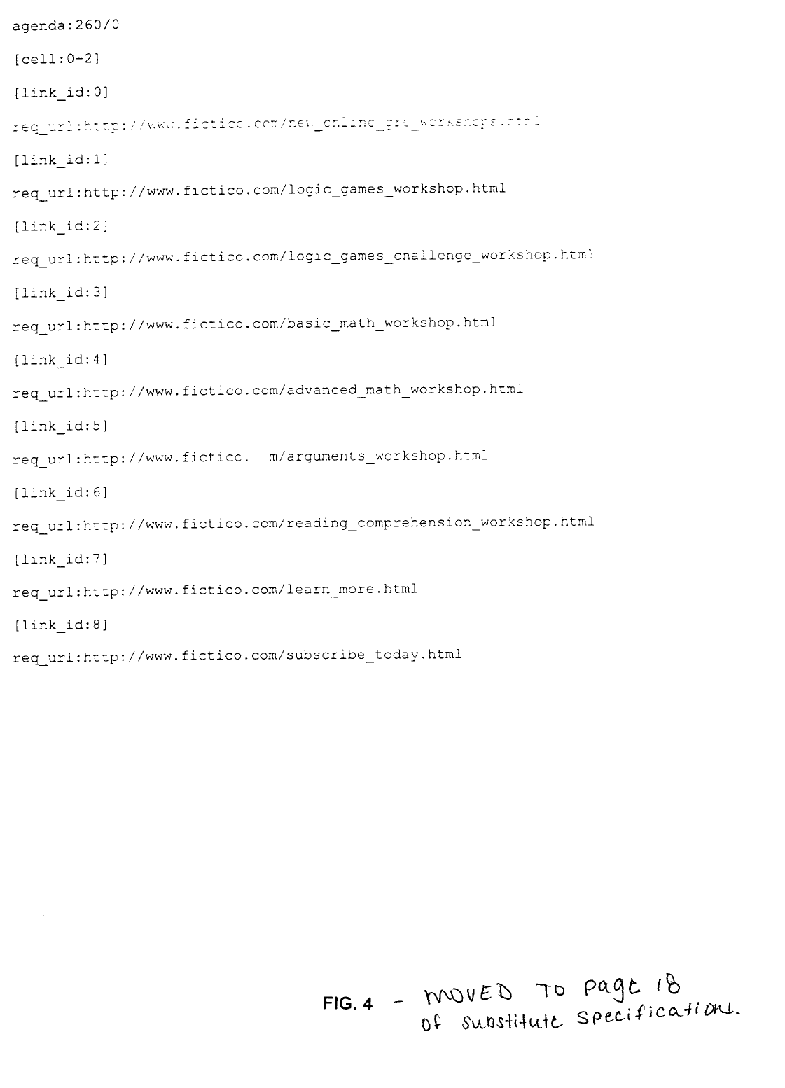

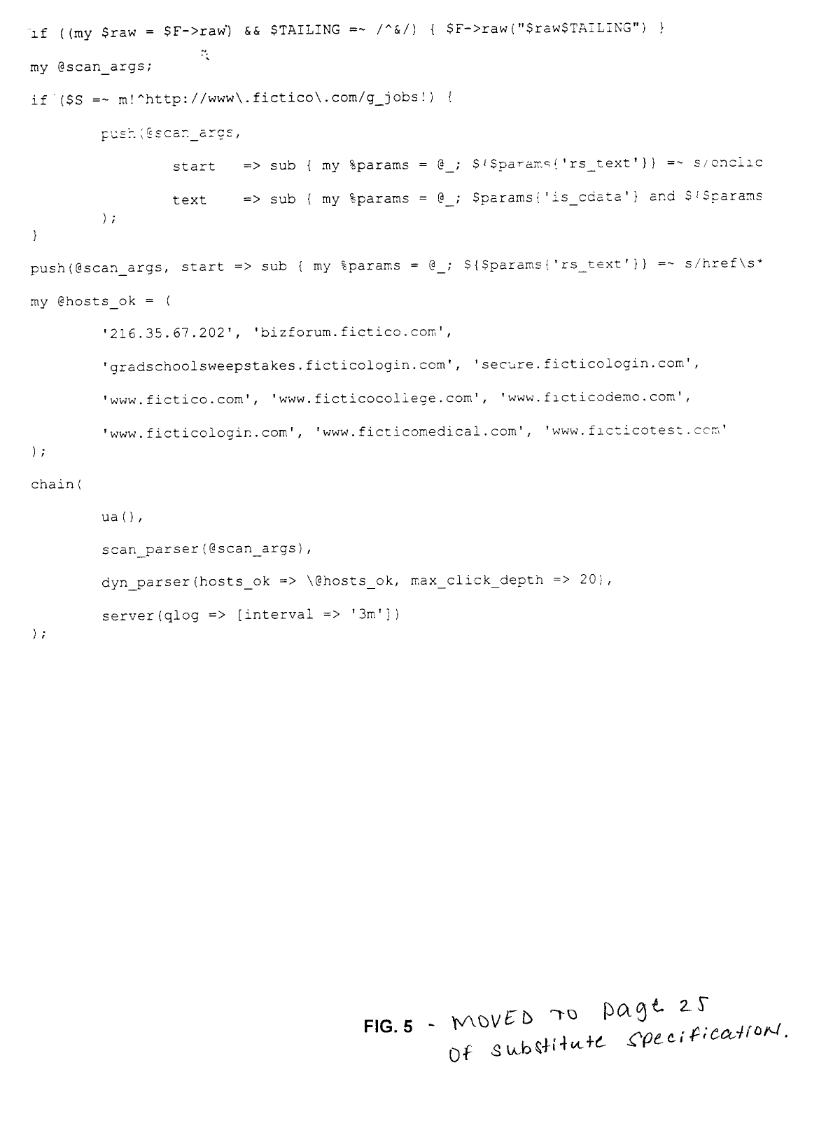

For the sake of our example, let us assume that FIG. 4 is a simple flat file created at a previous time, (identified by the CLIENT ID/CAMPAIGN ID portion of the CONTEXT as “260/5”), that will serve as the database for our LOOKUP. Using as an index to this database the CELL ID/LINK ID portion of the CONTEXT, “0:0,” APT comes away with an AGENDA ID of “260/0/0” and the REQ URL, “http://www.fictico.com/new₁₃ online_gre_workshops. html.”

At step 112 in the process, APT locates and runs an AGENDA SCRIPT, possibly identified by the TRANSACTION PARAMETER AGENDA ID that may have been obtained at a previous step.

An AGENDA SCRIPT can be a script that specifies an action or a series of actions that APT should perform during a given transaction, and can contain any of the features common to many programming languages, such as variables, operators, conditionals, looping, functions, objects, garbage collection, etc. An AGENDA SCRIPT will have available to it any of the data available to APT at the time of its execution, such as TRANSACTION PARAMETERS and HTTP parameters, as well as a library of functions and object classes intended to provide various forms of Internet functionality, text parsing, database connectivity, etc.

There are many actions and combinations of actions that can be specified in an AGENDA SCRIPT; listing all would be impractical but an example can illustrate the point. As simple non-limiting instances of these actions presented in no particular order, the AGENDA SCRIPT applicable to a transaction can specify that APT should do one or more of the following:

(1) perform a LOOKUP of some kind;

(2) run a different AGENDA SCRIPT;

(3) write an entry to a log file, in any format, that includes any desired information related to the transaction, including such information as TRANSACTION PARAMETERs; HTTP parameters, including form data and cookie data; any information resulting from a LOOKUP; system information; etc.;

(4) update a database with any desired information related to the transaction, as above;

(5) send an email to the user or to a third party, whether in confirmation of an action just performed by the user, or for some other reason;

(6) occurring at step 112b in FIGS. 1 and 10: issue to the TRUE WEB CLIENT an HTTP redirect to the REQ URL (or to a different URL entirely);

(7) occurring at step 112a in FIGS. 1 and 10: formulate an HTTP request for the REQ URL (or for a different URL entirely), issue it to the TRUE WEB SERVER, emulating the TRUE WEB CLIENT in as many or few particulars as desired, or not at all, and receive any HTTP response;

(8) generate an original dynamic HTML document, and prepare an HTTP response therefrom;

(9) parse and/or modify the headers and/or content of an HTTP request or response in any way;

(10) occurring at step 112b in FIGS. 1 and 10: issue to the TRUE WEB CLIENT an HTTP response acquired, created, and/or modified by APT;

(11) etc.

Although an AGENDA SCRIPT can specify any action or actions desired, there are two common requirements:

(1) record all information related to a transaction as is necessary to serve the particular use to which the process of FIGS. 1 and 10 is put;

(2) occurring at step 112b in FIGS. 1 and 10: serve back to the TRUE WEB CLIENT some HTTP response.

Where tracking the user's actions through one or more foreign Web sites as a third party is concerned, the AGENDA SCRIPT can specify at least the following:

(1) record all information related to a transaction as is necessary to serve the particular use to which the process of FIG. 10 is put;

(2) occurring at step 112a in FIGS. 1 and 10: formulate an HTTP request for the REQ URL, issue it to the TRUE WEB SERVER, emulating the request of the TRUE WEB CLIENT, and receive any HTTP response;

(3) modify the HTTP response so received such that any or all URLs therein are LOADED LINKs. This process is termed LINK LOADING. LINK LOADING can be performed by APT automatically for any document using a substitution routine called and configured in the AGENDA SCRIPT. A typical instance of LINK LOADING involves setting the “REQ URL” TRANSACTION PARAMETER of a LOADED LINK to contain the URL as it would have appeared were the link NOT loaded;

(4) occurring at step 112b in FIGS. 1 and 10.: serve back to the TRUE WEB CLIENT the LINK-LOADED HTTP response, emulating the response of the TRUE WEB SERVER.

Note that, at step 112b, APT is interacting with the server upon which the desired Web resource resides, the TRUE WEB SERVER, in the role of Web client; and that, at step 112a, APT is once again interacting with the TRUE WEB CLIENT in the role of Web server.

In any case, if the TRUE WEB CLIENT is served nothing, or is served an HTTP response not containing LOADED LINKs, then the APT session can end at step 112, as an APT session is generally perpetuated by a series of LOADED LINKs being activated at the TRUE WEB CLIENT. Otherwise, the APT session can continue at step 102 if, at the TRUE WEB CLIENT, a LOADED LINK in the newly served HTTP response is activated.

Let us resume our example at the end of step 110. To recap, APT has at this point received a request from the user as a result of the user clicking a LOADED LINK in the email letter she or he received; also, APT has extracted various TRANSACTION PARAMETERS from the request, filling in all gaps as necessary. The parameters germane to this example are: (1) USER ID, or “chris.geen@etracks.com”; (2) CONTEXT, or “:260/5:0:0”; (3) AGENDA ID, or “260/0/0”(acquired in a LOOKUP based on the CONTEXT); (4) REQ URL, or “http://www.fictico.com/new_online_gre_workshops.html”(acquired in a LOOKUP based on the CONTEXT); and (5) various HTTP parameters, such as USER_AGENT, HTTP_COOKIE, any form data, etc.

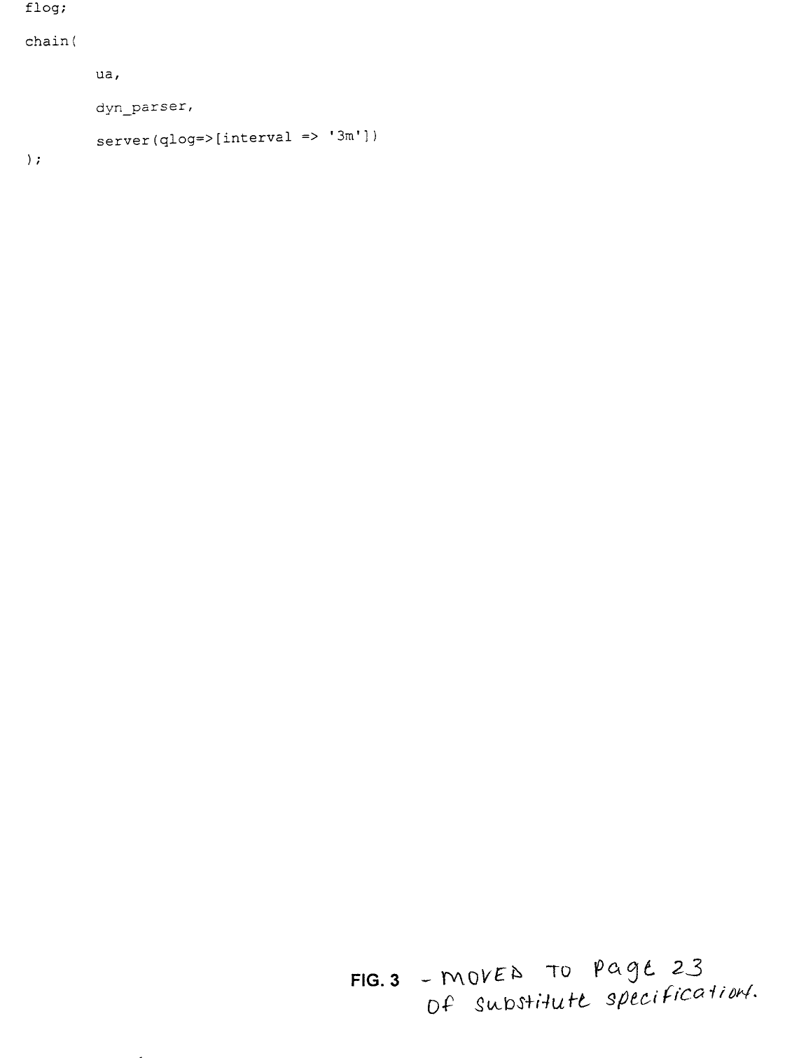

Now, taking step 110 from the top, APT runs the AGENDA SCRIPT identified by the AGENDA ID “260/0/0”(or some suitable default AGENDA SCRIPT should “260/0/0” not be available). A possible embodiment of this AGENDA SCRIPT is illustrated in FIG. 3., and will serve for this basic example. In short, referring to the lines in FIG. 3 and counting blank lines as well, this AGENDA SCRIPT specifies: (line 3) that pipeline processing be established to speed the actions to follow; (line 5) that an HTTP request be issued, emulating the TRUE WEB CLIENT's HTTP request as closely as possible (calling into play any necessary HTTP parameters), in order to retrieve the Web resource designated by REQ URL; (line 7) that any URLs in the HTTP response from the true Web server (as a result of the foregoing action) indiscriminately be converted into LOADED LINKs; and (line 9) that the modified HTTP response be served back to the TRUE WEB CLIENT, emulating as closely as possible the TRUE WEB SERVER. Line 1, incidentally, causes any form data submitted as part of the TRUE WEB CLIENT's HTTP request to be logged to a default location; and the “qlog” bit in line 9 causes critical TRANSACTION and HTTP PARAMETERs to be logged to a default location, also, at three-minute intervals.

So if the Web resource retrieved from the TRUE WEB SERVER at line 5 in the AGENDA SCRIPT of FIG. 3 were an extremely simple HTML page, say:

<HTML><BODY>

<HEAD><TITLE>New Online GRE Workshops</TITLE></HEAD>

Here is some very informative copy about New Online GRE Workshops.

<A HREF=“http://www.fictico.com/yet_more.html”> Click here for yet more information. </A>

</BODY></HTML> . . . then at line 7 in the AGENDA SCRIPT, the URL “http://www.fictico.com/yet_more.html” might be converted into the LOADED LINK: http://ap.etracks.com/apt?URcVG9iUZxshmerXxshmerXmZS3mZS3w8R5cVG9iUZ . . . whose encoded query string portion may contain the TRANSACTION PARAMETERS:

USER ID: chris.geen@etracks.com;

CONTEXT: 260/5:0:0;

AGENDA: 260/0/0;

SOURCE: http://www.fictico.com/new_online_gre_workshops.html;

and REQ URL: http://www.fictico.com/yet_more.html . . . resulting in the modified HTML page:

<HTML><BODY>

<HEAD><TITLE>New Online GRE Workshops</TITLE></HEAD>

Here is some very informative copy about New Online GRE Workshops.

<A HREF=“

http://ap.etracks.com/apt?URcVG9iUZxshmerXxshmerXmZS3mZS3w8R5 cVG9iUZ”>Click here for yet more information.</A>

</BODY></HTML>

. . . that may then served back to the TRUE WEB CLIENT at AGENDA SCRIPT line 9.

Should the user at the TRUE WEB CLIENT activate the LOADED LINK in this document, the APT session continues at step 102 in FIG. 2 and has the same host/path portion—“ap.tracks.com.” Note also that each of the loaded links has a query string portion delimited by a question mark “?” on the left and containing encoded transaction parameters.

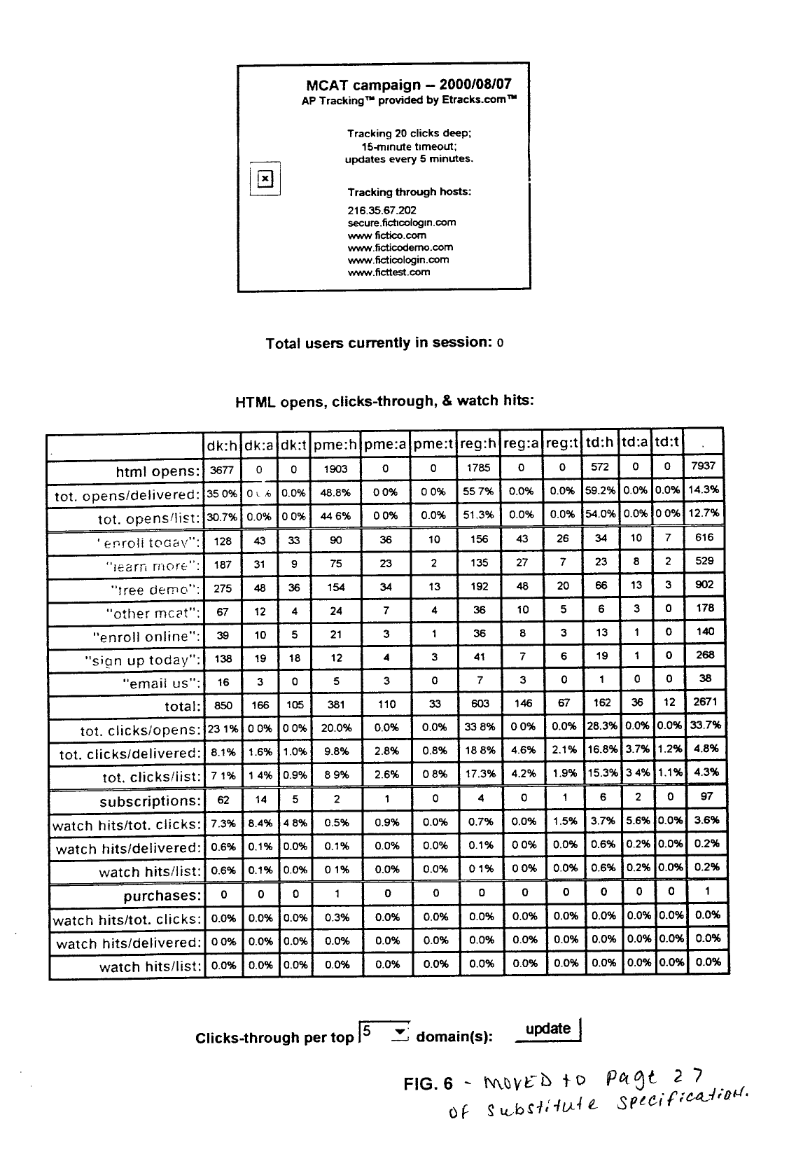

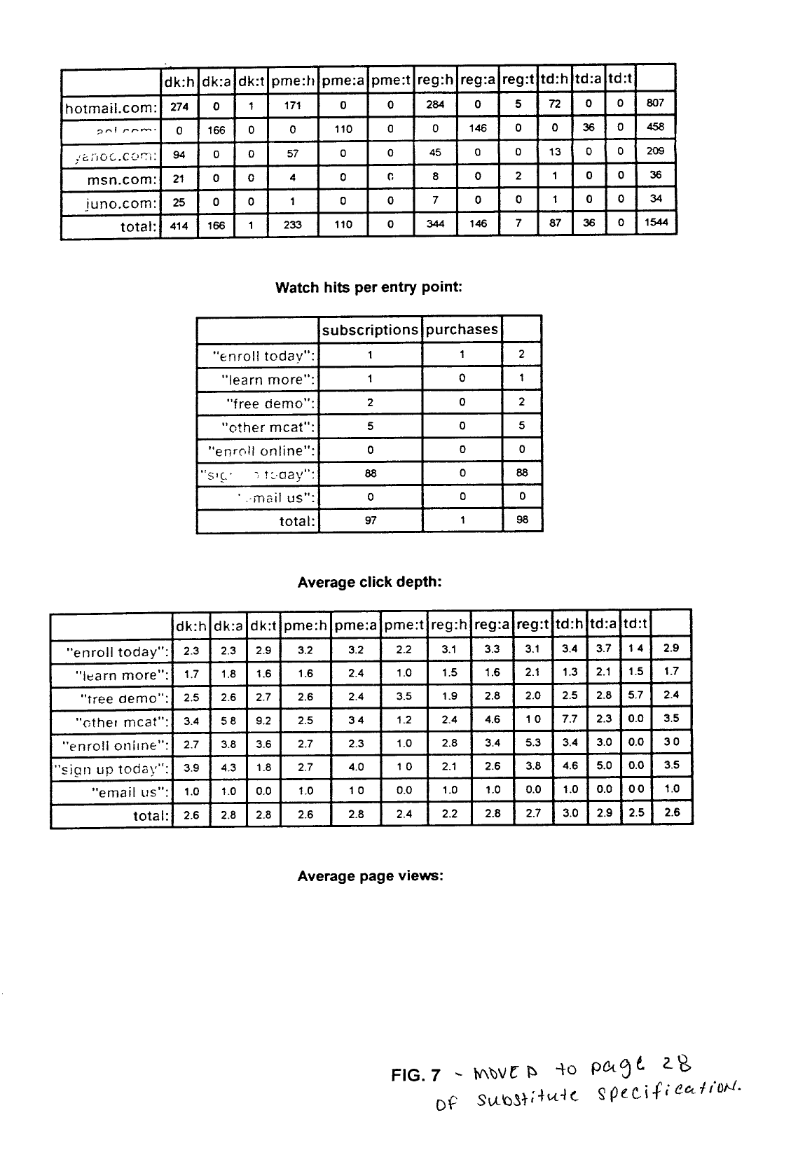

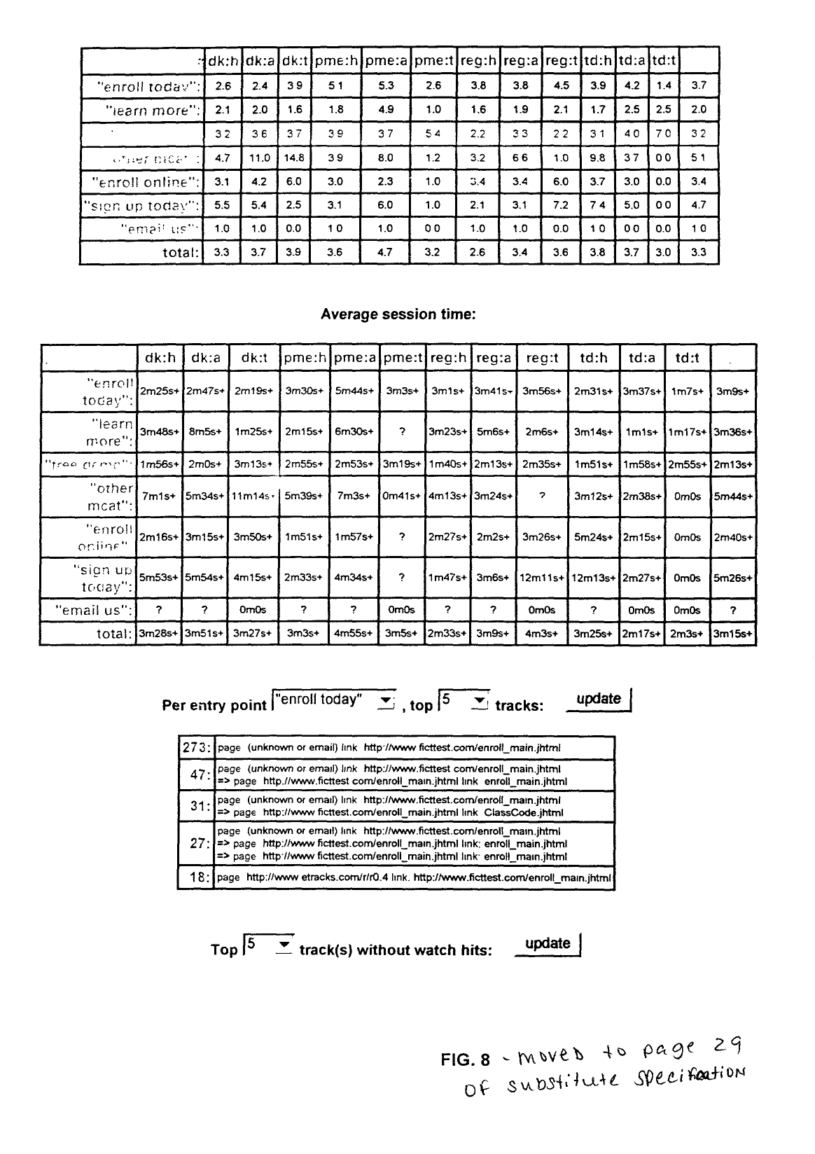

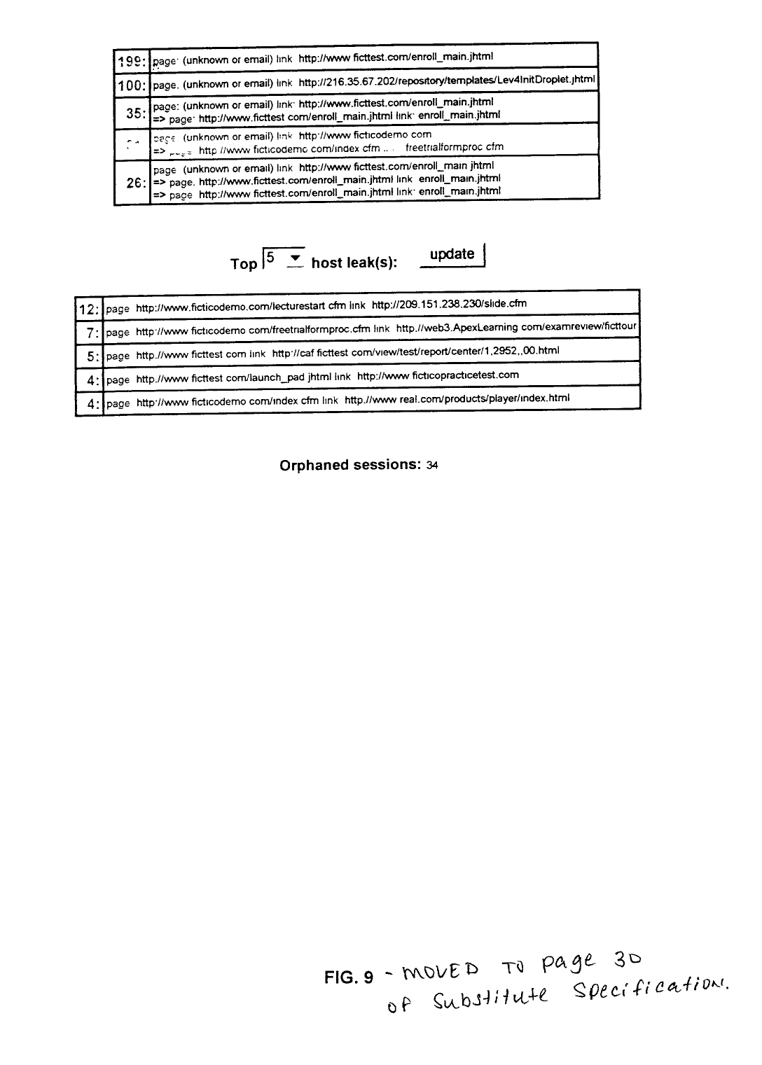

FIGS. 6-9 illustrate some of the information types logged by the APT in the process described above and some of the ways the APT organizes and present such information. In FIG. 6, the chart shows information about the numbers of html documents open by users during a specified time period, the number of click-through events, and the number of watch hits by users. The column headings refer to cells, such as in an email to users, and the row labels refer to items such as the html documents opened by users, the particular entry points on such documents selected by users, watch hits by users, and relationships between number entries. FIG. 7 illustrates three charts organizing logged information differently. The upper chart shows the number of clicks from users in respective domains in a certain time period, the middle chart shows the number of watch hits per entry point, and the lower chart shows the average click depth. In FIG. 8, the upper chart shows the average page views, the middle chart shows the average session time, and the lower chart shows the top five tracks per entry point. In FIG. 9, the upper chart shows the top five tracks without watch hits and the lower chart shows the top five host leaks.

It should be clear to those skilled in the technology to which this patent specification pertains that the examples discussed above are only illustrative, and that the disclosure above and the patent claims below encompass many other examples of the principles disclosed herein, and that those principles may be applied and implemented in a variety of ways encompassed by the patent claims set forth below.

1. A method of tracking a user's transactions with multiple Web resources and hosts in a Web session without a need to modify user-side hardware or software or to store cookies at user-side hardware, comprising:
utilizing an entry point related to an action of the user during the Web session to route a user's request for a Web resource to a gateway facility;
extracting session parameters from information available to the gateway facility as a consequence of said routing; and
tracking transactions that the user routed to the gateway server carries out with multiple Web resources and hosts in the Web session.

2. A method as in claim 1 in which said tracking comprises routing transactions between the user and said multiple Web resources and hosts through said gateway facility.

3. A method as in claim 2 in which said tracking further comprises modifying information transmitted at least in one direction between the user and said multiple Web resources at a location functionally intermediate the user and the Web resources.

4. A method as in claim 3 in which said modifying comprises modifying information transmitted in each direction between the user and the multiple Web resources.

5. A method as in claim 4 in which said modifying comprises modifying hyperlinks in information transmitted from said multiple Web resources to the user to cause the modified hyperlinks to point to the gateway server.

6. A method as in claim 5 in which said modifying comprises modifying information in addition to hyperlinks in information transmitted from said multiple Web resources to the user.

7. A method as in claim 6 in which said modifying comprises modifying URL information transmitted from the user and sending the modified URL information to at least one of said multiple Web resources.

8. A method as in claim 7 in which said modifying comprises consulting an agenda of rules relating information directed to the gateway facility and information sent from the gateway server to at least one of the user and the multiple Web resources.

9. A method as in claim 8 in which said modifying comprises modifications in accordance with instructions contained in said agenda.

10. A method as in claim 1 in which said entry point comprises a loaded link selected by the user in a Web session.

11. A method as in claim 10 in which said loaded link is in an email message to the user.

12. A method as in claim 10 in which said loaded link is in a Web page transmitted to the user.

13. A method as in claim 1 in which said extracting comprises filling in gaps in the extracted parameters.

14. A method as in claim 1 in which said tracking comprises selectively modifying information transmitted between the user and the multiple Web resources in accordance with instructions stored for use by the gateway facility.

15. A method of tracking a user through multiple Web resources and hosts in a Web session comprising:
(a) receiving at a gateway facility information resulting from a user activating, in said Web session, an entry point related to a request by the user for a Web resource from a server different from the gateway facility;
(b) extracting session parameters from said request, modifying the request in accordance with an agenda, and sending the modified request to the Web resource, said modified request pointing to the gateway facility;
(c) receiving a response to the modified request at the gateway facility, modifying the received response in accordance with said agenda, and sending the modified response to the user, said modified response containing an entry point to the gateway facility in a request for another Web resource;
(d) receiving at the gateway facility a request for said another Web resource resulting from the user activating, in said Web session, the entry point in the modified response; and
(e) creating a record of user actions related to the entry points recited in steps (a) and (d).

16. A method as in claim 15, further including repeating steps (b) and (c) for the request for said another Web resource.

17. A method as in claim 15 in which said modifying comprises modifying URL information contained in said response.

18. A method as in claim 17 in which said modifying further includes modifying information in said responses different from URL information.

19. A method as in claim 15 in which said steps (b) and (c) are repeated for a number of requests made by the user for Web resources from a number of different Web servers.

20. A method as in claim 15 in which said modifying of requests includes filling gaps in said requests before sending modified requests from said gateway facility. before sending.

21. A system for tracking a user's transactions with multiple Web resources in a Web session without a need to modify user-side hardware or software or to store cookies at user-side hardware, comprising:
a gateway facility functionally intermediate a user-side hardware and software and Web resources stored at resource facilities different from the gateway facility;
said gateway facility being configured to respond to a user's request routed thereto as a result of the user activating an entry point in a Web session to extract session parameters from the request, modify the request to cause a response thereto to be routed to the gateway facility, and to send the request to a resource facility;
said gateway receiver further being configured to receive a response from said resource facility to the modified request, to modify the response to include an entry point in a request for another Web resource, and the send the modified response to the user;
said gateway facility being responsive to the user activating said entry points to create and maintain a record of user actions related to activation of said entry points.

22. An Internet method comprising:
sending information to a user side computer facility, said information containing a loaded link containing address information pointing to a Web resource and to a gateway facility;
responding to a user activation of the loaded link to send at least a portion of said address information to the gateway facility;
processing the transmitted information to produce and send a request for the Web resource to a first server facility different from the user side facility and from the gateway facility;
responding to the request sent from the gateway facility by sending the Web resource from said server to the gateway facility, modifying the Web resource by modifying links therein to point the gateway facility, and sending the modified response to the user side facility;
In response to user activation of a modified links, receiving information related to the modified link at said gateway facility, processing the received information, and transmitting the resulting processed information to a second server facility different from the user side facility and from the gateway facility; and
using the gateway facility to create and maintain a record at least of user interaction with said links.
